(19) United States
(12) Patent Application Publication
(10) Pub. No.: US 2003/0003263 A1
(43) Pub. Date: Jan. 2, 2003

(54) Kit for making decorative articles

(76) Inventor: Ronald L. Smith, Placentia, CA (US)

Correspondence Address: McDERMOTT, WILL & EMERY, 600 13th Street, N.W., Washington, DC, 20005-3096, US

(21) Appl. No.: 10/162,591

(22) Filed: Jun. 6, 2002

Related U.S. Application Data
(60) Provisional application No. 60/295,829, filed on Jun. 6, 2001.

(51) Int. Cl. B05D 1/14

(52) U.S. Cl. 428/90

(57) ABSTRACT

A kit for making a decorative article includes a support having a grid array on the surface thereon, a plurality of colored tiles, and a source of information for communicating or illustrating how each of the tiles correspond to the grid array. Embodiments include a stiff support comprising any one or more of cardboard, heavy cardstock, foam board, wood, etc. and having a length and a width of each of from about 6 inches to about 60 inches and a thickness of about ⅛ inch to about ½ inch where the grid array is printed on a surface thereof and comprises a plurality of regularly shaped segments and each segment contains a symbol or number therein.

### FIELD OF THE INVENTION

The present invention relates to a kit and a method for making decorative articles, and more particularly, to a kit including a support and a plurality of colored elements to adhere to the support to form a decorative pattern.

### BACKGROUND ART

It is known in the prior art to make decorative articles through the use of templates. U.S. Pat. No. 4,355,722 to Lemmeyer discloses a yarn coloring picture set and a method of coloring. In this patent, a picture receiving board is provided having an adhesive layer coated thereon. Sections of yarn are applied to the adhesive layer using a yarn pencil.

U.S. Pat. No. 3,570,435 to Morrison discloses a method of making decorative articles employing yarn utilizing a base having a piercable elastic surface and a penetratable yieldable interior. Free ends of a yarn strand are pushed into the base in accordance with the picture thereon.

U.S. Pat. No. 2,435,068 to Bellamy discloses a method of knitting design wherein the design of the knitted article is determined by knitting in succession units that may contain yarns of various characteristics such as color.

It is also known to provide a kit for craft use. U.S. Pat. No. 4,310,313 to Brundige discloses a needleworking kit that includes a graph marked in colors to indicate where stitches are to be made on the grid of a canvas. The kit also includes instructions, one or more needles of the type required for needlepoint design and a supply of yarns in colors called for by the design.

In the manufacture of carpet, U.S. Pat. No. 3,285,797 to Harrison et al discloses a novel carpet construction wherein individual pile tufts extend through a backing fabric. The pile tufts are attached to the backing fabric using an adhesive and, optionally, a fusion treatment.

The aforementioned prior art has significant drawbacks in conjunction with kits and methods for making decorative articles. For example, the patents to Brundige, Morrison and Lemmeyer require the use of tools such as needles or other elongated implements for completing the decorative article. These tools require dexterity by a user and the ability to align the tool with a given pattern or form. Moreover, prior art patterns or templates also require complicated attachment features such as the perforated bases disclosed in the Morrison and Lemmeyer patents.

A kit and method for making decorative articles, as disclosed in U.S. Pat. No. 5,447,770 to Smith, teaches several improvements in this art. The kit includes a fabric grid, a multicolored template, yarn segments and an adhesive wherein the yarn segments are adhesively applied to the fabric grid according to the multicolored template.

A continuing need exists, however, to provide a kit and a method for making decorative articles that is simple to assemble yet effective in producing a finished product and which avoids complicated tools and/or patterns to facilitate attachment of yarn-like material.

### SUMMARY OF THE INVENTION

Accordingly, an advantage of the present invention is a kit containing elements for making decorative articles which is simple to use but provides a highly detailed, decorative article.

Another advantage of the present invention is a method of making an aesthetically decorative article

Additional advantages and features of the invention will be set forth in part in the description which follows and in part will become apparent to those having ordinary skill in the art upon examination of the following or may be learned from the practice of the invention. The advantages of the invention may be realized and obtained as particularly pointed out in the appended claims.

According to the present invention, the foregoing and other advantages are achieved in part by a kit that includes the combination of a support having a grid array on one surface thereof; a plurality of colored tiles; and a source of information for communicating or illustrating how each of the plurality of tiles corresponds to the grid array to form the decorative article.

Embodiments of the present invention include a stiff support comprising any one or more of cardboard, heavy cardstock, foam board, wood, etc. and having a length and a width of each from about 6 inches to about 60 inches and a thickness of about ⅛ inch to about ½ inch where the grid array is printed on a surface thereof and comprises a plurality of regularly shaped segments and each segment contains a symbol or number therein.

The tiles contemplated by the present invention include tile comprising paper, fabric, plastic, chip board, vinyl or any combination thereof and have an area of from about ¼ in² to about 1 in², e.g. from about ⅓ in² to about ½ in² where several tiles have differing colors or shading or both. Particularly suited tiles have a high glossy finish and an adhesive backing for adhering the tile to the support. Alternatively, the tiles can be adhered to the support by applying a liquid adhesive to either the support or tile.

Another aspect of the present invention is a method of making a decorative article. The method comprises providing a support having a grid array on one surface thereof, wherein the grid array contains a plurality of regularly shaped segments; providing a plurality of tiles, each tile having an area and color; providing a source of information for communicating or illustrating how each of the plurality of tiles corresponds to the grid array; and attaching each tile to each of the of segments making up the grid array by referring to the source of information illustrating how each of the plurality of tiles corresponds to each of the plurality of segments of the grid array to form the decorative article.

Additional advantages of the present invention will become readily apparent to those skilled in this art from the following detailed description, wherein only the preferred embodiment of the present invention is shown and described, simply by way of illustration of the best mode contemplated for carrying out the present invention. As will be realized, the invention is capable of other and different embodiments, and its several details are capable of modifications in various obvious respects, all without departing from the present invention. Accordingly, the drawing and description are to be regarded as illustrative in nature, and not as restrictive.

### BRIEF DESCRIPTION OF DRAWINGS

Reference is now made to the drawings accompanying the invention wherein:

FIG. 1 is a representation of a portion of a support having a printed template in accordance with an embodiment of the inventive kit and method.

FIG. 2 is a representation of a completed decorative article made from a kit in accordance with an embodiment of the present invention.

### DESCRIPTION OF THE INVENTION

The present invention provides improvements over prior art kits and methods for making decorative articles. The kit and method of the present invention provides a simple and effective means for producing a unique tile-like art work with a high level of definition. The inventive kit and method eliminate the need for tools or implements to form the decorative article such that the kit can be mastered by young and old without the need for exceptional dexterity by a user.

Through the use of a support having a grid array containing a plurality of regularly shaped segments together with a plurality of differently colored tiles an in conjunction with a source of information illustrating how each of the differently colored tiles corresponds to each of the segments of the grid array, decorative articles can be produced having an intricate combination of colors and patterns in a simple series of steps.

The inventive kit and method is adaptable for decorative articles that can be used as wall hangings. The inventive kit and method is especially adaptable for retail use and is ideal for the home art and craft works.

In accordance with the inventive kit a support is provided having a grid array. The support can comprise a variety of materials as known in the art of arts and crafts and any equivalent thereof. In an embodiment of the present invention, the support comprises a stiff material so that the support can be easily mounted on a wall or framed. For example the support can comprise at least one layer of foam having thereon at least on layer of paper, as in conventional foam board. Other examples of support materials include cardboard, cardstock, wood and the like. The support can have a length and a width of each of from about 6 inches to about 60 inches, e.g. from about 6 inches to about 36 inches and a thickness of about ⅛ to about 1 inch.

The grid array can be printed on the support, mounted on the support, embossing or provided by other known methods. The grid array can cover the entire surface of the support or a portion thereof. In an embodiment of the present invention, a grid array containing a plurality segments where each segment contains a symbol or number therein.

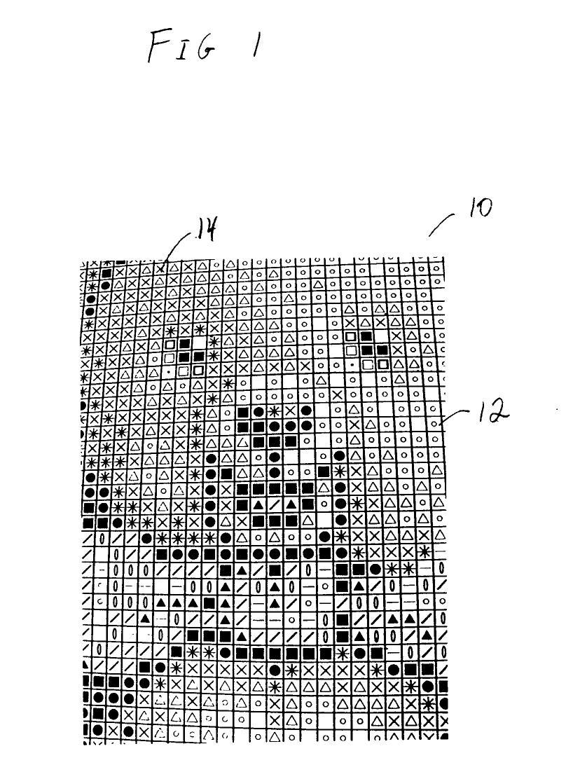

As illustrated in FIG. 1., grid array 10, can be arranged in square segments 12. The square segments can be identified by symbols 14 contained therein. These symbols assist in visualizing the design contemplated in the finished decorative article.

Still with reference to FIG. 1, the grid array segments are sized to correspond to the tiles to put placed thereon and have an area of approximately ⅓ in² to about ½ in². The tile dimension is only limited by the resolution desired in the finished article. In one aspect of the present invention, the tile area can be as low as ⅛ in² and as high as about ½ in². In completing the decorative article a plurality of differently colored tiles can be placed on the plurality of segments of the grid array.

The tiles can comprise any suitable material, as for example, paper, fabric, plastic, chip board, vinyl or any combination thereof and have a self adhesive backing, as such adhesive backings are known in the art. In one aspect of the present invention, the tiles comprise a paper and plastic stock having a high glossy finish and an adhesive backing. In an embodiment of the present invention, the tiles comprise a plurality of colors, such as browns, tans, blues, reds, pinks, black, white, etc. and can have a variety of shadings of any one or more of the colors.

In accordance with the present invention, a source of information communicating or illustrating how individual tiles correspond to the grid array is provided. In an embodiment of the present invention the source of information comprises an instruction sheet providing a key code that illustrates which particularly colored or shaded tile corresponds to a particular symbol. For example, each segment having a filled circle therein corresponds to a cream colored tile, each segment having a filled square therein corresponds to a black colored tile, each segment having a filled triangle therein corresponds to a medium tan colored tile, while each segment having an “X” therein corresponds to a light brown colored tile, etc. Although the embodiment of FIG. 1 illustrates only eight different indicia, each indicia having a respective color or shading associated therewith, any number of colors and indicia can be used in conjunction with a design on the grid array to form a decorative article.

In practicing the present invention, individual tiles are attached to each of the segments making up the grid array by referring to the source of information illustrating how each of the plurality of tiles corresponds to each the plurality of segments of the grid array. In one aspect of the present invention, the tiles comprise an adhesive backing to facilitate adherence of the tile to the grid. Alternatively, a bead of adhesive can be applied to each tile or on to the grid or both. This sequence is continued until each segment of the grid array includes a respective tile therewith to form a unique tile-like art work.

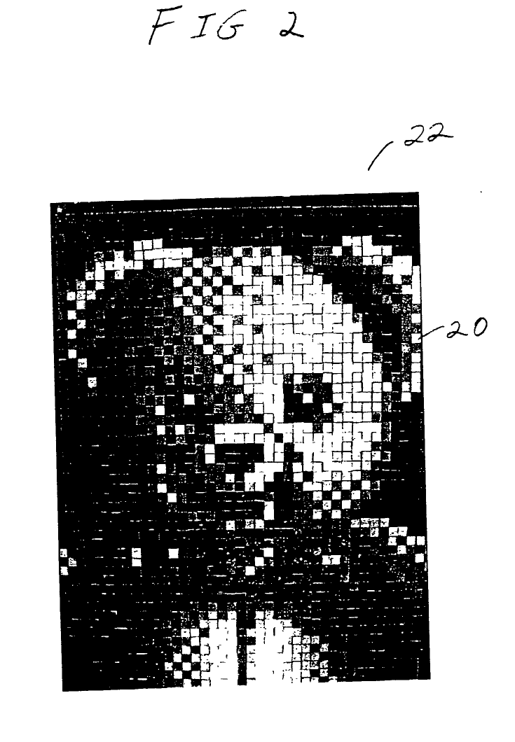

With reference now to FIG. 2, an exemplary finished product is illustrated and is seen to include a plurality of square segments 20, each square segment including individual tile having a particular shading to form the desired decorative article. Although the square segments 20 of the grid array 22 are shown as differing in shading, the several tile can differ in color. Any configuration for a segment may be utilized in conjunction with the inventive method and kit. Square, rectangle, triangular, although square segments are more convenient since it is easier to finish the decorative article by applying the tile in these square segments.

In kit form, the invention includes the support with the grid array thereon, the tiles in the appropriate colors to match the colors described by the source of information, e.g. a template and key as in an instruction sheet, the adhesive, if not already on the tiles. To facilitate transport of the kit, the contents thereof can be contained in a suitable container, in particularly a container for holding the components in a compact manner. Preferably, the holding container would include a reproduction of the template design on the outside thereof to inform a potential user as to the decorative article to be made.

As such, an invention has been disclosed in terms of preferred embodiments thereof which fulfill each and every one of the objects of the present invention as set forth herein above and provide a new and improved kit and method for making a decorative article.

The present invention is applicable to various and obvious modifications. Only the preferred embodiment of the present invention and an example of its versatility is shown and described in the present disclosure. It is to be understood that the present invention is capable of use in various other combinations and environments and is capable of changes or modifications within the scope of the inventive concept as expressed herein.

What is claimed is:

1. A kit for making a decorative article comprising:
a support having a grid array on one surface thereof;
a plurality of tiles, each tile having an area and a color; and
a source of information for communicating or illustrating how each of the plurality of tiles corresponds to the grid array to form the decorative article.

2. The kit according to claim 1 wherein the support comprises foam board or cardboard.

3. The kit according to claim 1 wherein the support has a length and a width of each of from about 6 inches to about 60 inches.

4. The kit according to claim 1 wherein each tile comprises paper, fabric, plastic, chip board, vinyl or any combination thereof.

5. The kit according to claim 1 wherein the plurality of tiles comprise several tiles differing in color or differing in the shading of a color.

6. The kit according to claim 1 wherein the plurality of tiles comprise a card-stock, paper or paper and plastic, having a high glossy finish.

7. The kit according to claim 1 wherein several of the plurality of tiles comprise an adhesive backing for adhering the tile to the support.

8. The kit according to claim 1 wherein the plurality of tiles have an area of from about ⅛ in² to about ½ in².

9. The kit according to claim 1 wherein the plurality of tiles have an area of from about ⅓ in² to about ½ in².

10. A kit for making a decorative article comprising:
a support having a grid array on one surface thereof, wherein the grid array contains a plurality of regularly shaped segments and each segment contains a symbol or number therein;
a plurality of paper tiles having a high glossy surface and an opposing surface having an adhesive, wherein several of the tiles differ in color or shading and have an area of from about ⅛ in² to about ½ in²; and
a source of information illustrating how the several tiles correspond to the grid array to form a decorative article.

11. A method of making a decorative article comprising:
providing a support having a grid array on one surface thereof, wherein the grid array contains a plurality of regularly shaped segments;
providing a plurality of tiles, each tile having an area and color;
providing a source of information for communicating or illustrating how each of the plurality of tiles corresponds to the grid array; and
attaching each tile to each of the of segments making up the grid array by referring to the source of information illustrating how each of the plurality of tiles corresponds to each of the plurality of segments on the grid array to form the decorative article.
